(19) United States
(12) Patent Application Publication
(10) Pub. No.: US 2007/0135114 A1
(43) Pub. Date: Jun. 14, 2007

(54) Platform selection for wireless communication

(76) Inventor: Randy Valentino, Arlington Heights, IL (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/300,555

(22) Filed: Dec. 14, 2005

(51) Int. Cl. H04Q 7/20

(52) U.S. Cl. 455/422.1

(57) ABSTRACT

A platform selection system and methods for wireless communication are provided. In an illustrative implementation, a wireless communication system maintains at least one wireless communications device operable to be in communication with one or more wireless communications platforms. Further, in the illustrative implementation, the wireless communications device can comprise a platform selection mechanism, and a platform selection instruction set that instructs the platform selection mechanism to select one or more of the wireless communications platforms for communication of data. In the illustrative operation, a platform selection engine operating on the wireless communications device monitors the execution of one or more selected criteria by the wireless communications device. Relying on one or more instructions of a platform selection instruction set, the platform selection mechanism allows the wireless communications device to cooperate with a selected one or more wireless communications platforms based on the execution of one or more selected criteria.

### TECHNOLOGY FIELD

The herein described systems and methods relate to wireless data communications and, more particularly, to platform selection for wireless communications.

### BACKGROUND

The proliferation of wireless technologies has allowed for the development of various wireless communications platforms, protocols, and paradigms for the wireless communication of data. Such wireless communication platforms, protocols, and paradigms include code division multiple access (CDMA), time division multiple access (TDMA), global system for mobile communications (GSM), global packet radio service (GPRS), 802.11x (WI-FI), and 802.16 (WiMax). The wireless technologies generally operate to sample data (e.g., voice or data) and communicate such data over a selected radio frequency range between cooperating devices that employ such wireless technologies. As such, each of the wireless platforms, protocols, and paradigms operate within a selected frequency range (e.g., GPRS—850 MHz and/or 1900 MHz, WI-FI−2.4/5 GHz) and generally are not compatible with each other. Stated differently, for example a device employing GPRS generally cannot operate on a wireless network operating CDMA.

Generally, devices having wireless data communication capabilities operate to communicate data using a selected wireless communication protocol. The data is communicated over a cooperating wireless communications platform capable of processing the same wireless communication protocol. Some of these wireless communications platforms can be geographic specific and may not offer network coverage in rural areas. Additionally, some of the wireless communications platforms can impose additional restrictions on the use of the platform by requiring the wireless devices to maintain special hardware components (e.g., a SIM card required-on devices employing the GSM wireless communication protocol).

Comparatively, some of the wireless communications platforms operate to allow for the wireless communication of voice/data over local wireless communication platforms e.g., WI-FI local area network). Such wireless communication platforms generally operate on smaller distances (˜300 meters) and maintain a communications architecture in which the end (e.g., file server, print server, mail server, etc.) and/or to a larger computer network (e.g., Wide Area Network (WAN), the Internet). With current practices, a number of WI-FI access points (e.g., “hot-spots”) can be propagated through out a selected geographic area to create a “connectivity grid” allowing cooperating devices to be in continuous communication with a particular network (e.g., the Internet). For example, several municipalities (e.g., Philadelphia, San Jose, San Francisco, etc.) have or are in the process of establishing a municipal WI-FI grid that encompasses the municipality so that a cooperating device (e.g., a WI-FI enabled laptop or PDA) can roam through the city and have access to communications network (e.g., the Internet) to which the WI-FI communications platform is connected.

However, current wireless communication practices are not without limitations. Most significantly, as described, the wireless communications platforms generally operate using differing wireless communication protocols having differing operating requirements (e.g., operating at different frequencies) typically rendering a device enabled for a first wireless communication platform useless on a second wireless communication platform. The lack of interoperability between wireless communication platforms can be cumbersome for the end-user. Specifically, with current practices, an end-user might have to enable the cooperating wireless communications device (e.g., wireless PDA) with various hardware and/or software additions (e.g., a WI-FI adapter, a GSM adapter, a CDMA adapter etc). Additionally, the end-user might have to manually configure the wireless communications device to switch wireless communication operations from one wireless communications platform to another.

There are several solutions that have been developed that strive to overcome the incompatibility problem that exists between these various wireless communication platforms. Specifically, multi-modal wireless communications devices have been developed. In such context, a multi-modal wireless communications device can include the hardware (and accompanying software) to employ and utilize more than one wireless communication platform, protocol, or paradigm. For example, a multi-modal (multi-band) mobile telephone (personal digital assistant), can have the hardware/software to be able to employ the CDMA and GSM wireless communication protocols. Such devices can operate to communicate data over CDMA wireless networks when operating in a geographic region supporting CDMA (e.g., United States) and GSM wireless networks (e.g., Europe) when operating in a geographic region supporting GSM.

However, current multi-modal wireless communication devices generally operate to cooperate with a particular type of wireless communications platform such as a cellular wireless communications platform (e.g., device operates on GSM and GPRS wireless communications platforms) and not between varying types of wireless communications platforms (e.g., between WI-FI and cellular). Moreover, current multi-modal wireless communication devices and practices are not criteria driven and/or process driven so that the cooperating wireless communications device is instructed to operate on a first wireless communications platform (i.e., select and operate on a first wireless communications frequency band) when one or more criteria/processes are satisfied/executed (e.g., operate on WI-FI platforms when engaging in task A) and to operate on a second wireless communications platform (e.g., select and operate on a second wireless communications frequency band) when one or more second criteria/processes are satisfied/executed (and operate on CDMA platforms when engaging in Task B). Rather, current multi-modal wireless communications devices operate to continuously poll and locate suitable cooperating wireless communications platforms of a given wireless communications platform type (e.g., to locate all GPRS and GSM cooperating platforms) to perform selected communications tasks. Such selection of the wireless communications platform is not based on selected criteria being satisfied or processes being executed but rather on what suitable (e.g., what can work with the device) wireless communications platform is available to the cooperating multi-modal wireless communications device. Also, such selection does not switch over between various wireless communications platforms automatically.

From the foregoing, there exists a need for systems and methods that overcome the shortcomings and limitations of existing practices.

### SUMMARY

A platform selection system and methods for wireless communication are provided. In an illustrative implementation, a wireless communication system maintains at least one wireless communications device operable to be in communication with one or more wireless communications platforms. Further, in the illustrative implementation, the wireless communications device can comprise a platform selection mechanism, and a platform selection instruction set that instructs the platform selection mechanism to select one or more of the wireless communications platforms for communication of data.

In an illustrative operation, the wireless communications device can cooperate with one or more wireless communications platforms. In the illustrative operation, a platform selection engine operating on the wireless communications device monitors the execution of one or more selected criteria by the wireless communications device. Relying on one or more instructions of a platform selection instruction set, the platform selection mechanism allows the wireless communications device to cooperate with a selected one or more wireless communications platforms based on the execution of one or more selected criteria. In the illustrative implementation, the one or more criteria can comprise one or more steps of a selected process.

Other features and operations of the herein described systems and methods are described below.

### BRIEF DESCRIPTION OF THE DRAWINGS

A platform selection system and methods are further described with reference to the accompanying drawings in which:

FIG. 1 is a block diagram of an exemplary wireless communications environment in accordance with an implementation of the herein described systems and methods;

FIG. 2 is a block diagram showing the cooperation of exemplary components of an illustrative implementation in accordance with the herein described systems and methods;

FIG. 3 is a flow diagram of exemplary processing performed in an illustrative operation in accordance with the herein described systems and methods; and

FIG. 4 is a flow diagram of other exemplary processing performed in an illustrative operation in accordance with the herein described systems and methods.

### DETAILED DESCRIPTION

Overview:

The proliferation of wireless communications technologies have availed various applications including but not limited to mobile telephony and mobile data communication (e.g., wireless Internet, enterprise data reporting, wireless logistics processing, to name a few). With increasing adoption and deployment, a plurality of wireless communications platforms have been developed that offer various benefits when compared against each other. The relative benefits of one or more of currently available wireless communications platforms can be used to determine whether to use one wireless platform over another when wirelessly communicating data.

For example, cellular wireless communications platforms (e.g., code division multiple access (CDMA), time division multiple access (TDMA), global system for mobile communications (GSM), general packet radio service (GPRS)), because of their technical architecture can be deployed over larger geographic areas. However, the deployment of such wireless communications platforms can be costly as unique hardware and software are required to operate cellular wireless communication platform types. Such cost can often be transferred to the end user by charging a relatively large amount to use such wireless communication platform types.

Comparatively, wireless communications platforms like those based on the IEEE 802.11X standard (e.g., WI-FI) are technically architected to work over much smaller geographic areas (˜1000 feet) which can be a disadvantage to an end-user. However, the hardware and software associated in operating a WI-FI wireless communications platform cost much less than the hardware and software used in the operation of a cellular wireless communication platform. As such, the end-user (e.g., an operator of a WI-FI enabled wireless communications device) can be positioned to pay less for the use of a WI-FI wireless communications platform. Also as an added benefit, WI-FI communications platforms can operate to provide access to an underlying communications network (e.g., the Internet, a local area network (LAN), or a wide-area network (WAN)).

However, there exists a significant drawback with current wireless communications technologies. Namely, there is a lack of interoperability between the various wireless communications platforms. Stated differently, a wireless device enabled to operate on a GSM wireless communications platform is rendered useless if it were to be used with a CDMA or with a WI-FI wireless communications platform. As such, multi-modal wireless communication devices have been developed to allow the multi-modal wireless communications device to operate on more than one wireless communications platform. However, current multi-modal wireless communication devices operate so that the multi-modal wireless communication device operates on wireless communications platforms of the same type—i.e., cellular type wireless communications platforms. Further, current multi-modal wireless communication devices operate to switch between wireless communications platform of the same type using a polling routine. That is, the multi-modal wireless communication device constantly keeps polling nearby wireless communications platforms of a particular type (e.g., cellular wireless communications platforms) to identify available and cooperating wireless communications platforms. Once a suitable wireless communications platform of a particular type is located, the multi-modal wireless communications device activates the corresponding transceiver to operate on the identified available wireless communications platform. As such, current multi-modal wireless communication devices are rendered useless to operate with more than one wireless communication platform type and do not operate to allow for the switch-over between differing wireless communications platforms driven by the satisfaction of one or more criteria.

The herein described systems and methods aim to ameliorate the shortcomings of existing practices by provided a platform selection system and methods for wireless communication that allows a wireless communications device to operate on differing wireless communications platforms (having various types) and that allows such switchover between differing wireless communications platforms based on the satisfaction of one or more selected criteria. In an illustrative implementation, a wireless communications system is provided comprising a wireless communications device having one or more transceivers operable to wirelessly communicate data with one or more wireless communications platforms. Further, the wireless communications device can comprise a platform selection engine having one or more platform selection instructions to instruct the platform selection engine to select a transceiver for wireless communication of data on a cooperating wireless communications platform based on the satisfaction of one or more selected criteria.

In an illustrative operation, selected criteria for the operation of an exemplary wireless communications device can be set. The one or more selected criteria can be processed by the exemplary platform selection engine to determine if the criteria have been satisfied, and, if satisfied, select one of available transceivers found in the exemplary wireless communications device to wirelessly communicate data with a cooperating wireless communications platform. As such a wireless communications device is provided that is operable on wireless communications platforms of various types and that operates to select the wireless communications platform, that is to be used to wirelessly communicate data, based on the satisfaction of one or more criteria.

Illustrative Wireless Communication Environment:

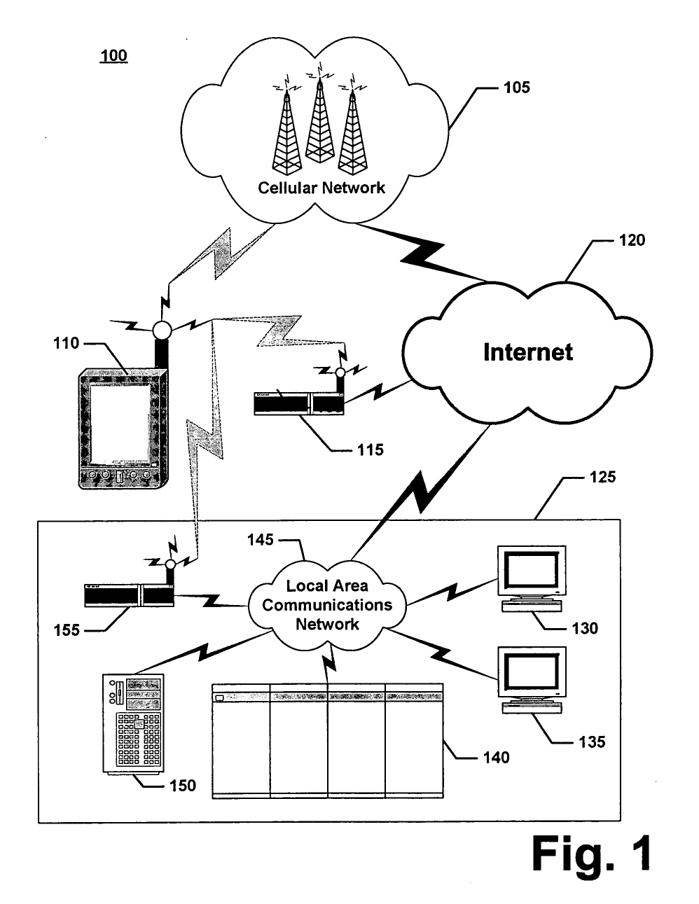

FIG. 1 is a block diagram of exemplary wireless communications environment 100. As is shown in FIG. 1, exemplary wireless communications environment 100 comprises wireless communications device 110 that is coupled to a number of exemplary wireless communications platforms, such as cellular platform 105 and wireless communications platform environment 125. Further as is shown in FIG. 1, cellular platform 105 and/or wireless communication platform environment 125 can be coupled to the Internet 120. Additionally, wireless communications device 110 can cooperate with the Internet 120 thought wireless router 115.

In the illustrative implementation, wireless communications platform environment 125 can comprise local area communications network 145 that can be coupled to one or more of: wireless router 155, server computing environment 150, host computing environment 140, and client computing environments 130 and 135, respectively. As is shown in FIG. 1, wireless router 155 of wireless communications platform environment 125 can cooperate with wireless communications device 110 (as indicated by the dotted communication network connectors) to wirelessly communicate data between wireless communications device 110 and wireless communications platform environment 125. In the illustrative operation, wireless communications platform environment 125 can allow for the communication of various data to and from any of server computing environment 150, host computing environment 140, and client computing environments 130 and 135 with wireless communications device 110 using local communications network 145 coupled to wireless router 155.

In the illustrative implementation, wireless communications device 110 can comprise one or more transceivers (not shown) that can be used to communicate with various wireless communications platforms such as cellular network 105, wireless routers 115 and/or 155 and wireless communications platform environment 125. Additionally, in the illustrative implementation, wireless communications device 110 can further comprise a platform selection engine (not shown) that instructs wireless communications device 110 to communicate with a selected wireless communications platform based on the satisfaction of selected criteria. In the illustrative operation, wireless communications device 110 can be pre-configured with the selected criteria used to select the wireless communications platform with which it can wirelessly communicate data and can operate to seamlessly switch between cooperating wireless communications platforms based on one or more of the selected criteria being satisfied.

Multi-Modal Wireless Communication:

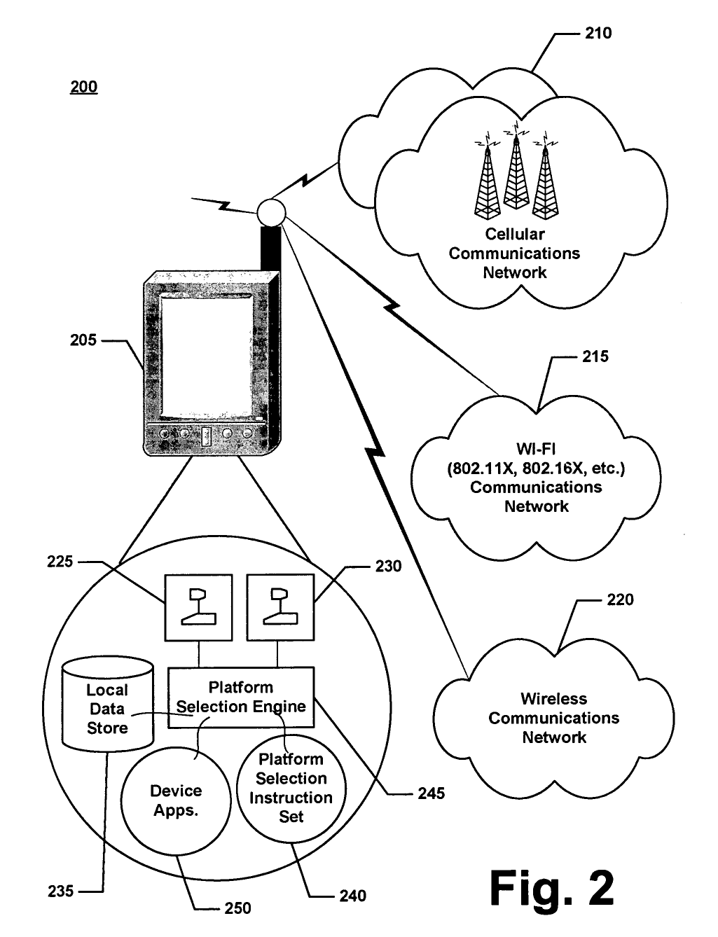

FIG. 2 shows exemplary wireless communications environment 200 and an illustrative implementation of the interaction between the various components of the exemplary wireless communications environment 200. As is shown in FIG. 2, exemplary wireless communications environment 200 comprises wireless communications device 205 cooperating with various wireless communications platforms that include but are not limited to cellular communications network 210, WI-FI communications network 220, and other wireless communications network 220 (e.g., WiMax communications network). Additionally, as is shown, wireless communications device 205 comprises transceivers 225 and 230, local data store 235, platform selection engine 245, platform selection instruction set 240, and device applications 250.

In an illustrative operation, platform selection engine 245 can operate on wireless communications device 205 to select a wireless communications platform (e.g., cellular communications network 210, WI-FI communications network 215, or other wireless communications network 220) using platform selection instruction set 240. The selection of which wireless communications platform can be based on which of the selected criteria (not shown) have been satisfied and in accordance with platform selection instruction set 240. Further, in the illustrative operation, the selected criteria can be generated by one or more processes being executed by one or more device applications 250.

In the illustrative operation, the selected criteria can be satisfied such that a first wireless communications platform is chosen and data can then be communicated by wireless communications device 205, using data retrieved from local data store 235, over one of transceiver (i.e., the transceiver that will allow wireless data communication with the selected wireless communication platform) 225 or 230. Further, in the illustrative operation, the selection of the wireless communications platform can change if the selected criteria change and the new selected criteria have been satisfied. In such context, platform selection 245 engine can operate to switch-over from using one wireless communications platform to another (i.e., based on the satisfaction of new selected criteria) in an seamless manner. Further in the illustrative implementation, data can be stored in local data store 235 acting as a data buffer such that if the wireless communications platform changes (e.g., cellular communications network 210 is first selected based on the satisfaction of first selected criteria and then switched over to WI-FI communications network 215 based on the satisfaction of second selected criteria) while data is being communicated, the data can be retrieved from local data store 235 for re-communication over the switched-over wireless communications platform. Additionally, in the illustrative operation, device applications 250 can cooperate with local data store 235 to store and retrieve various data for use by device applications 250 and/or by wireless communications device 205.

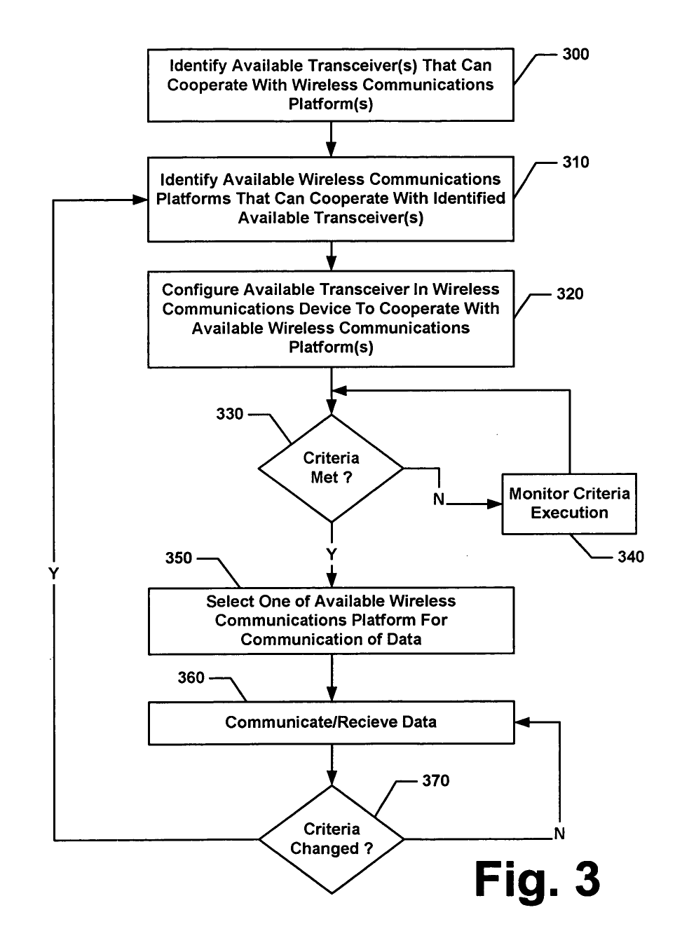

FIG. 3 shows exemplary processing performed by an illustrative wireless communications platform 200 of FIG. 2. As is shown in FIG. 2, processing begins at block 300 where available communication interface(s) of an exemplary wireless communications device (not shown) are identified such that the identified communication interface(s) can cooperate with one or more wireless communications platforms. From there, processing proceeds to block 310 where available wireless communications platforms are identified that can cooperate with the identified and available transceiver(s). Processing then proceeds to block 320 where the available transceivers in the exemplary wireless communications device are configured to cooperate with the identified and available wireless communications platforms. In an illustrative implementation, transceiver(s) of blocks 300, 310, and 320 can comprise wireless communication transceivers operating at a selected frequency.

A check is then performed at block 330 to determine if one or more selected criteria have been satisfied. If the check at block 330 indicates that selected criteria have not been satisfied, processing proceeds to block 340 where the execution of various criteria is monitored. From there, processing reverts back to block 330 and proceeds from there.

However, if at block 330 it is determined that selected criteria have been satisfied, processing proceeds to block 350 where one of the available wireless communications platforms is selected for data communication based on the criteria that were satisfied. Processing then proceeds to block 350 where data is communicated and received between the exemplary wireless communications device (not shown) and the selected available wireless communications platform.

A check is then performed at block 370 to determine if any of the criteria which were used to select the wireless communication platform have changed. If the check at block 370 indicates that the criteria has changed, processing reverts back to block 310 and proceeds from there. However, if the check at block 370 indicates that the criteria used to select the wireless communications platform has not changed, processing reverts back to block 360 and proceeds from there.

In an illustrative implementation, the processing described in FIG. 3 can be applied to a wireless communications device such as mobile personal digital assistant (PDA) (not shown) used to surf the Internet. In this context, the mobile personal digital assistant can comprise a cellular based transceiver (e.g., GSM SIM card and associated hardware/software)(not shown) as well as a WI-FI transceiver (e.g., a WI-FI flash card and associated hardware/software)(not shown). In an illustrative operation, the mobile PDA can be configured to have the following criteria: 1) identify available WI-FI access points (“WI-FI hot-spots”), 2) identify available GSM cellular networks, 3) attempt to connect to available WI-FI hot-spots first and then connect to available GSM networks when wirelessly communicating data.

With such selected criteria, the mobile PDA can operate in accordance with the processing described in FIG. 3 to allow connectivity to the Internet first through available WI-FI hot-spots. In this context, based on the selected criteria, the mobile PDA would execute an exemplary platform selection engine process (not shown) to select available WI-FI hot-spots first when trying to connect to the Internet and use the WI-FI transceiver (not shown) of the mobile PDA when connecting to WI-FI hot-spots. If and when WI-FI hot-spots no longer are available, the exemplary platform selection engine would then attempt to connect a GSM cellular network using the GSM transceiver of the mobile PDA. In the illustrative implementation, the platform selection engine can operate in the background as a utility application on the mobile PDA such that the switch-over to the differing wireless communications platforms (e.g., from WI-FI to GSM, and vice-versa) is seamless to the end-user of the wireless communications device (e.g., mobile PDA).

It is appreciated that the illustrative implementation can describe an end-user who is surfing the Internet in a WI-FI enabled building and then leaves the building traveling in a car to second destination. In such context, in accordance with the processing described in FIG. 3, the exemplary mobile PDA platform selection engine can select to connect to a WI-FI hot-spot based on the above-described selected criteria when the mobile PDA is near a WI-FI hot-spot and seamlessly switch over to wireless communications on the GSM wireless communications platform when a WI-FI hot-spot is no longer available (e.g., when the end-user leaves the building and travels in the car). In the illustrative implementation, the selected criteria can be selected based on various factors including but not limited to use of the mobile PDA (i.e., is high bandwidth needed and if so for how long), cost (i.e., use inexpensive WI-FI connectivity first and then if that is made unavailable switch-over to wirelessly communicate data over more costly cellular networks), and reliability (i.e., use WI-FI in bad weather conditions when cellular connectivity can be made more suspect).

It is also appreciated that although the illustrative implementation is described in context of a mobile PDA capable of operating on WI-FI and GSM wireless communications platforms and having WI-FI and GSM transceivers and such selection of wireless communications is based on exemplary selected criteria that such description is merely illustrative as the inventive concepts described herein extend to various wireless communications devices having various transceivers that allow for operation on a variety of wireless communications platforms such that the operation of the wireless communications device with one more wireless communications platforms can be based on various selected criteria and not just the selected criteria described herein.

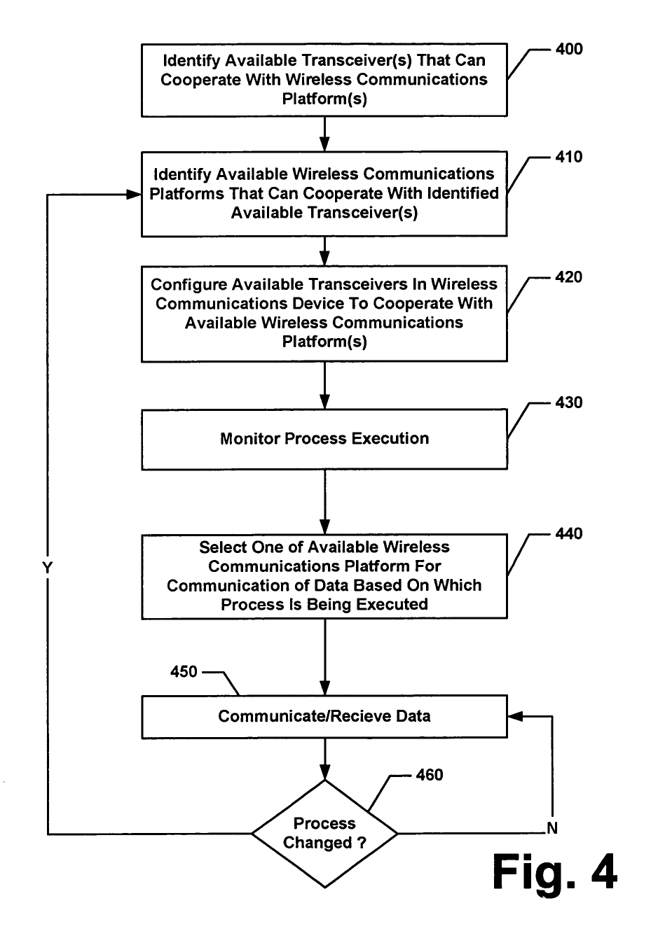

FIG. 4 shows other exemplary processing performed by an illustrative wireless communications platform 200 of FIG. 2. As is shown in FIG. 4, processing begins at block 400 where available communication interface(s) are identified in the exemplary wireless communications device (not shown) that can cooperate with one or more wireless communications platforms. From there processing proceeds to block 410 where available wireless communications platforms are identified that can cooperate with the identified and available transceiver(s). Processing then proceeds to block 420 where the available transceivers in the exemplary wireless communications device are configured to cooperate with the identified and available wireless communications platforms. In an illustrative implementation, transceiver(s) of blocks 400, 410, and 420 can comprise wireless communication transceivers operating at a selected frequency.

At block 430 one or more processes.(e.g., business processes, application execution processes) are monitored to see if they are executed. From there, processing proceeds to block 440 where one of the available wireless communications platforms is selected based on the process being executed. Processing then proceeds to block 450 where data is communicated and received between the exemplary wireless communications device (not shown) and the selected available wireless communications platform. A check is then performed at block 460 to determine if the process being executed has changed. If the check at block 460 indicates that the process being executed has changed, processing reverts back to block 410 and proceeds from there. However, if the check at block 460 indicates that the process used to select the wireless communications platform has not changed, processing reverts back to block 460 and proceeds from there.

In an illustrative implementation, the processing described in FIG. 4 can be applied to a wireless communications device such as mobile delivery computing tablet (not shown) used in logistics data monitoring for item delivery. In this context, mobile delivery computing tablet can comprise a cellular based transceiver (e.g., CDMA transceiver and associated hardware/software)(not shown) as well as a WI-FI transceiver (e.g., a WI-FI transceiver and associated hardware/software)(not shown). In an illustrative operation, the mobile delivery computing tablet can be configured to operated in the following modes based on the execution of the following described processes: 1) when executing a loading/unloading truck process (that is performed in or around a delivery warehouse) wirelessly communicate data using available WI-FI access points (“WI-FI hot-spots”), 2) when performing a “Begin” pickup/delivery process (i.e., when a delivery person begins his/her deliver run, the mobile delivery computing tablet operates to download the data relating to the items to be delivered by the delivery person—such process can be performed in or around the delivery warehouse) wirelessly communicate data using available WI-FI access points, 3) when performing a “Run” pickup/delivery process (i.e., the delivery person leaves the delivery warehouse to deliver the items for delivery on their delivery run) wirelessly communicate data using available cellular wireless communications platforms (e.g., CDMA cellular network), and 4) when performing an “End” pick/up delivery process (i.e., when the delivery person returns to the warehouse with returned or picked-up items—items picked up from another location while the delivery person is on their run) wirelessly communicate data using available cellular wireless communication platforms (e.g., CDMA cellular networks) first and then switch-over to WI-FI wireless communication platforms (e.g., available WI-FI hotspots) if the cellular wireless communications fail.

It is appreciated that the illustrative implementation can describe a wireless communications system having a plurality of mobile delivery computing tablets for use by delivery persons to wirelessly communicate data with a central delivery management center. In the illustrative implementation, the mobile delivery computing tablets can wirelessly communicate data back to the central delivery management center (e.g., the computing environment of the central delivery management center) using one or more wireless communications platforms (e.g., CDMA and/or WI-FI) such that the selection of the wireless communications platform can be based on the process being performed by the delivery person. As such, the mobile delivery computing tablets can maintain a platform selection engine using one or more platform selection instructions that instruct the mobile delivery computing tablet to select a particular wireless communication interface (i.e., CDMA transceiver or WI-FI transceiver) based on the process that is being performed by the delivery person in conjunction with the mobile delivery computing tablet. Further, in the illustrative implementation, the process driven platform selection can be realized such that the switch-over between bands is seamless to the delivery person. In this context, the mobile delivery computing tablets can be pre-configured such that security authorization and verification can be performed by the mobile delivery computing tablet as a background process not having to burden the delivery person with remembering log-in information.

It is also appreciated that although the illustrative implementation is described in context of a mobile deliver computing tablet capable of operating on WI-FI and CDMA wireless communications platforms and having WI-FI and CDMA transceivers and such selection of wireless communications is based on which process is being executed by the mobile delivery computing tablet that such description is merely illustrative as the inventive concepts described herein extend to various wireless communications devices having various transceivers that allow for operation on a variety of wireless communications platforms such that the operation of the wireless communications device with one more wireless communications platforms is based on the execution of various selected processes and not just those selected processes described herein.

It is understood that the herein described systems and methods are susceptible to various modifications and alternative constructions. There is no intention to limit the invention to the specific constructions described herein. On the contrary, the herein described systems and methods are intended to cover all modifications, alternative constructions, and equivalents falling within the scope and spirit of the herein described systems and methods.

It should also be noted that the herein described systems and methods may be implemented in a variety of computer environments (including both non-wireless and wireless computer environments), partial computing environments, and real world environments. The various techniques described herein may be implemented in hardware or software, or a combination of both. Preferably, the techniques are implemented in wireless computing environments maintaining programmable computers that include a processor, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output components. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although an exemplary implementation of the invention has been described in detail above, those skilled in the art will readily appreciate that many additional modifications are possible in the illustrative implementations without materially departing from the novel teachings and advantages of the herein described systems and methods. Accordingly, these and all such modifications are intended to be included within the scope of the herein described systems and methods. The herein described systems and methods may be better defined by the following exemplary claims.

What is claimed is:

1. A system for wireless communication comprising:
a wireless communications device having two or more transceivers; and
a selection engine operable on the wireless communications device having one or more instructions to instruct the wireless communications device to utilize one of the transceivers based on the satisfaction of one or more first selected criteria.

2. The system as recited in claim 1 further comprising one or more wireless communications platforms.

3. The system as recited in claim 2 wherein the one or more wireless communications platforms comprise code division multiple access (CDMA) wireless platform, time division multiple access (TDMA) wireless platform, global standard mobile (GSM) wireless platform, general packet radio service wireless platform, 802.11X (WI-FI) wireless platform, and 802.16X (WiMAx) wireless platform.

4. The system as recited in claim 1 wherein the selected wireless communication interface is operable to communicate data with a cooperating wireless communications platform.

5. The system as recited in claim 4 wherein the selection engine can seamlessly switch data communications from a first selected wireless transceiver cooperating with a first wireless communications platform to a second wireless transceiver cooperating with a second wireless communications platform.

6. The system as recited in claim 5 wherein the switch-over operation is driven by the satisfaction of one or more second selected criteria.

7. The system as recited in claim 6 wherein the one or more selected criteria comprise the execution of a selected business process.

8. The system as recited in claim 7 wherein the selected business process comprises a delivery logistics business process comprising loading a delivery truck, unloading a delivery truck, beginning a run for the delivery of items, delivering items, and ending a run for the delivery of items.

9. The system as recited in claim 8 wherein the selection engine selects a transceiver based on the execution of a selected business process.

10. The system as recited in claim 9 wherein a transceiver component operable to wirelessly communicate data with a cellular wireless communications platform is selected by the platform selection engine for business processes that are executed away from a delivery warehouse.

11. The system as recited in claim 9 wherein a transceiver component operable to wirelessly communicate data with a WI-FI wireless communications platform is selected by the platform selection engine for business processes that are executed proximate to a delivery warehouse.

12. A method for wireless communication of data comprising:
identifying one or more available wireless transceivers in an wireless communications device;
identifying available cooperating wireless communications platforms capable of cooperating with the identified available one or more wireless transceivers; and
selecting a wireless transceiver based on the satisfaction of one or more selected criteria.

13. The method as recited in claim 12 further comprising defining the selected criteria.

14. The method as recited in claim 13 further comprising communicating data by the wireless communications device using the selected wireless communications device.

15. The method as recited in claim 14 further comprising communicating data by the selected wireless communications device to a cooperating wireless communications platform.

16. The method as recited in claim 15 further comprising switching over to another identified available wireless communications device upon the satisfaction of one or more selected criteria.

17. The method as recited in claim 16 further comprising switching over to another identified available wireless communications device upon the satisfaction of one or more differing selected criteria.

18. A computer readable medium having computer readable instructions to instruct one or more computing components operating on a wireless communications device to perform a method comprising:
identifying one or more available wireless transceivers in an wireless communications device;
identifying available cooperating wireless communications platforms capable of cooperating with the identified available one or more wireless transceivers; and
selecting a wireless transceiver based on the satisfaction of one or more selected criteria.

19. A wireless communications system comprising:
a first means for wireless communicating data, the first means operable to wireless communicate with a first wireless communications platform;
a second means for wireless communicating data, the second means operable to wireless communicate with a first wireless communications platform; and
a third means for selecting a means for wireless communicating data based on the satisfaction of one or more selected criteria.

20. The system as recited in claim 19 further comprising a fourth means for instructing the third means to select the means for wirelessly communicating data.

21. The system as recited in claim 20 further comprising a fifth means for switching over between the first means wirelessly communicating data to the second means for wirelessly communicating data based on the satisfaction of one or more selected criteria.

22. A method for wireless communication of data comprising:
identifying one or more available wireless transceivers in an wireless communications device;
identifying available cooperating wireless communications platforms capable of cooperating with the identified available one or more wireless transceivers; and
selecting a wireless transceiver based on the execution of one or more business processes.

23. The method as recited in claim 22 further comprising monitoring the execution of the one or more business processes.

24. The method as recited in claim 23 further comprising communicating data by the wireless communications device using the selected wireless communications device.

25. The method as recited in claim 24 further comprising communicating data by the selected wireless communications device to a cooperating wireless communications platform.

26. The method as recited in claim 25 further comprising switching over to another identified available wireless communications device upon the execution of the one or more business processes.

27. A system for wireless communication comprising:
a wireless communications device having one or more communication interface components; and
a selection engine operable on the wireless communications device having one or more instructions to instruct the wireless communications device to utilize one of the communication interfaces based on the execution of one or more business processes.

28. The system as recited in claim 27 wherein the one or more selected business processes comprise logistic delivery business processes.

29. A method for wireless communication of data comprising:
identifying one or more available wireless transceivers in an wireless communications device;
identifying available cooperating wireless communications platforms of various wireless communication platform types capable of cooperating with the identified available one or more wireless transceivers; and
selecting a wireless transceiver;
communicating data by the selected wireless communications device to a cooperating wireless communications platform; and
switching over to another identified available wireless communications platform.

30. A computer readable medium having computer readable instructions to instruct one or more computing components operating on a wireless communications device to perform a method comprising:
identifying one or more available wireless transceivers in an wireless communications device;
identifying available cooperating wireless communications platforms of various wireless communication platform types capable of cooperating with the identified available one or more wireless transceivers; and
selecting a wireless transceiver;
communicating data by the selected wireless communications device to a cooperating wireless communications platform; and
switching over to another identified available wireless communications platform.

31. A hand-held wireless communication device capable of performing platform selection comprising:
two or more transceivers; and
a selection engine operable on the hand-held wireless communications device having one or more instructions to instruct the hand-held wireless communications device to utilize one of the transceivers based on the satisfaction of one or more selected criteria.

32. The device recited in claim 31 wherein the selected criteria comprise one or more steps of a selected business delivery process.

33. Computer software adapted for use on a wireless hand-held communications device performing a method comprising:
identifying one or more available wireless transceivers in an wireless communications device;
identifying available cooperating wireless communications platforms of various wireless communication platform types capable of cooperating with the identified available one or more wireless transceivers; and
selecting a wireless transceiver;
communicating data by the selected wireless communications device to a cooperating wireless communications platform; and
switching over to another identified available wireless communications platform.
